(19) United States
(12) Patent Application Publication
(10) Pub. No.: US 2020/0388191 A1
(43) Pub. Date: Dec. 10, 2020

(54) SENSORY TOY GEAR DEVICE

(71) Applicant: Kahalia MEGGO, Toronto (CA)

(72) Inventor: Kahalia MEGGO, Toronto (CA)

(21) Appl. No.: 16/430,556

(22) Filed: Jun. 4, 2019

(51) Int. Cl. G09B 19/00; G09B 5/04; B43K 29/00; B43K 24/02; B43K 5/14

(52) U.S. Cl. CPC G09B 19/0023; G09B 5/04; B43K 5/14; B43K 24/02; B43K 29/005

(57) ABSTRACT

The present invention is a sensory toy gear for use in connection with assisting an educationally-challenged student in developing higher skill sets such as color recognition, concentration and writing especially for autistic students. According to the invention, the sensory toy gear of the present invention assists in teaching higher level skills sets including those necessary and desirable for promoting learning and teaching autistic students to recognize the colors by way of sound produced by the educational tool. Specifically, the present invention is directed to a set of sound displays incorporating a set of colors incorporated into educational tool.

### FIELD OF THE INVENTION

The present invention relates in general to sensory toy gear devices and in specific to sensory toy gear devices for children who have autism and developmental disorders.

### BACKGROUND OF THE INVENTION

The term of “autism” comes from the Greek word autos (meaning self) and was used first by the Austrian psychiatrist Leo Kanner (1943). Autism is generally believed to be the result of a neurological disorder that affects the functioning of the brain, with a range of occurrences estimated at 2 to 6 per 1,000 births (Centers for Disease Control and Prevention, 2003). Autism involves not only developmental delays but atypical behaviors, lack of social interactions, language barriers, difficulty in color differentiations, and repetitive behaviors to a name few.

There exist few devices for teaching children letters and numbers. For example, U.S. Pat. No. 4,968,255 discloses an electronic interactive speech producing apparatus for instructing children in letters and numbers, where the apparatus in the form of a school bus, has a plurality of input sockets arranged at each window position of the school bus and answer blocks having complementary input detection elements for engagement with the input sockets. By inserting the answer blocks triggers an audible presentation of the letter or number displayed thereon.

WO00/01456 teaches controlling at least one device by incidental sound produced by a living creature and including: attaching a sound-maker to a living creature so that the natural movements of the living creature will cause the sound-maker to emit a sound; receiving the sound by at least one device; and responding by some physical response to the sound, by the at least one device. The sound may be, for example, ultrasound, infra-sound, or audible sound, and the toy response may be movement or production of a sound or a light display, or a response on a computer screen. The toy includes components which receive and analyze the acoustic signal and, depending on the particular signal received, the toy produces a corresponding response, such that interaction between the user and toy is simulated.

WO00/15316 teaches toys which transmit acoustic, encoded, electromagnetic, or light signals and respond thereto, by simulating interaction between toys. These toys can communicate by a computer, are not required to be stationed at the same location in order to transmit and receive signals.

US20130130587 discloses a toy apparatus and method for interactive communication between a cellphone and a toy apparatus where a signal is transmitted from the cell phone and is received by the toy apparatus and the apparatus produces a response. But none of the prior art inventions disclose sensory toy gear devices for children with Autism or other development delay disorders.

None of the devices from the prior art can assist autistic students in developing higher skill sets, especially for color recognition, concentration or writing. Therefore, it is desirable to provide an educational tool for use in connection with assisting a developmentally challenged student in developing higher skill sets, and especially for autistic students.

### SUMMARY OF THE INVENTION

The present invention is a sensory toy gear for use in connection with assisting an educationally-challenged student in developing higher skill sets such as color recognition, concentration and writing especially for autistic students.

According to the invention, the inventive sensory toy gear assists in teaching higher level skills sets including those necessary and desirable for promoting learning and teaching autistic students to recognize the colors by way of sound produced by the educational tool. Specifically, the present invention is directed to a set of sound displays incorporating a set of colors incorporated into educational tool.

According to the invention, the sensory toy gear comes with different colors, shapes, grips with certain characteristic information. That information includes shape information, textural information, and color information. Each character may include a single or multiple piece of information incorporated therein. For example, a shape information may include textual information or color information, or both in integrated form. Textual information may include shape information, color information or both integrated form. Color information may include solid color information or the shape information, or textural information.

According to the invention, the sensory toy gear comes with different color ink cartridges for different color sounds representing the sound to color of the spectrum. The sensory toy gear further comes with different shapes and grips for developing motor skills.

It is therefore an object of the present invention to assist autistic students in developing higher skill sets, especially for color recognition, concentration or writing.

It is another object of the present invention to provide an educational tool for use in connection with assisting a developmentally challenged student in developing higher skill sets, and especially for autistic students.

It is another object of the present invention to assist in teaching higher level skills sets including those necessary and desirable for promoting learning and teaching autistic students to recognize the colors by way of sound produced by the educational tool.

As used herein, the recited terms have the following meanings. All other terms and phrases used in this specification have their ordinary meanings as one of skill in the art would understand. Such ordinary meanings may be obtained by reference to technical dictionaries, known to those skilled in the art.

To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 illustrates a side view of sensory toy gear with the tip in protracted position;

FIG. 2 illustrates a side of the sensory toy gear with the tip in retracted position;

FIG. 3 illustrates the aerial view of the speaker present on the sensory toy gear;

FIG. 4 illustrates the inside view of the speaker sensory toy gear;

FIG. 5A illustrates an embodiment of the sensory toy gear;

FIG. 5B illustrates another embodiment of the sensory toy gears;

FIG. 5C illustrates another embodiment of the sensory toy gears;

FIG. 5D illustrates another embodiment of the sensory toy gear;

FIG. 5E illustrates another embodiment of the sensory toy gears;

FIG. 5F illustrates another embodiment of the sensory toy gears;

FIG. 5G illustrates another embodiment of the sensory toy gears, and

FIG. 6 illustrates the color and sound correspondences chart.

### DETAILED DESCRIPTION OF PREFERRED EMBODIMENTS

The figures are not intended to be exhaustive or to limit the present invention to the precise form disclosed. It should be understood that the invention can be practiced with modification and alteration, and that the disclosed technology be limited only by the claims and equivalents thereof.

The device disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

The detailed description as set forth below in connection with the appended drawings is intended as a description of the presently preferred embodiments of the present invention and is not intended to represent the only form(s) in which the present invention may be constructed or utilized. The description sets forth functions and sequence of steps for constructing and operating the invention in connection with the illustrated embodiments. It is to be understood, however, the same or equivalent functions and sequences may be accomplished by different embodiments and that they are also intended to be encompassed within the spirit and scope of this invention.

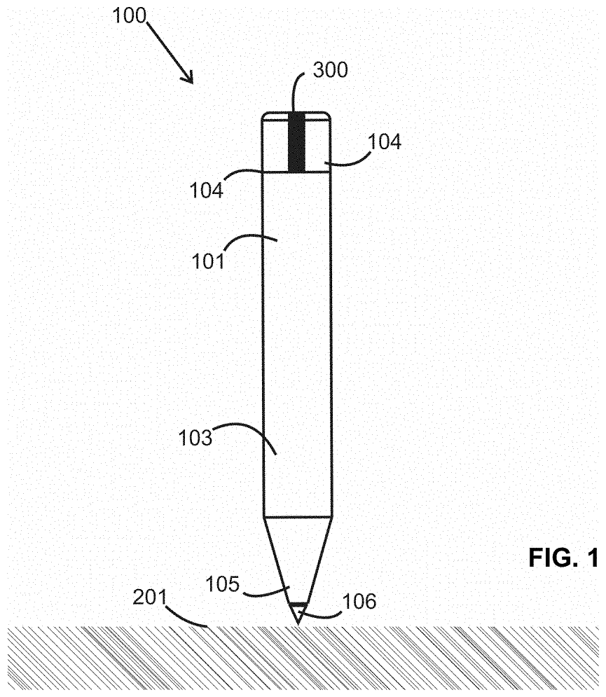

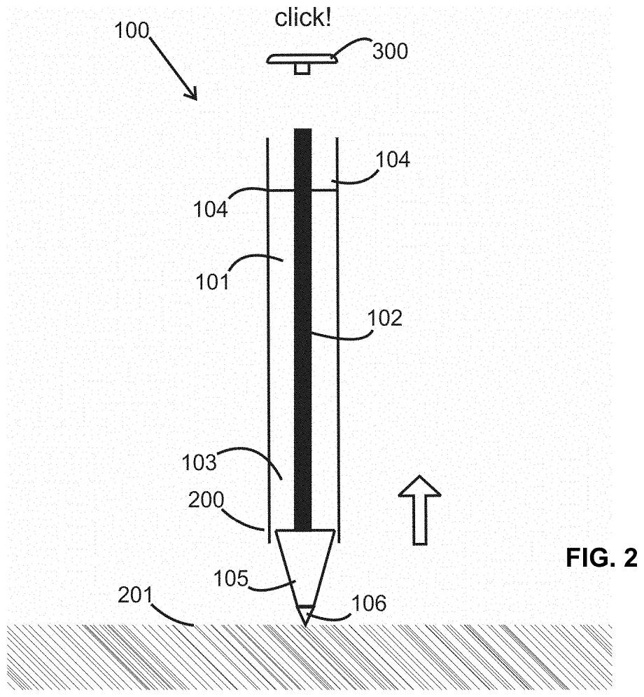

With reference to the drawings FIGS. 1 and 2, represent a first preferred embodiment of the present invention, directed to sensory toy gear 100 for use in connection with assisting educationally-challenged students, including autistic students, in developing higher skill sets. According to the invention, the sensory toy gear 100 has a housing 101 comprising an ink cartridge 102. The housing 101 has a body 103, a bottom end 104 and a Tip 105. Tip 105 comprises an aperture 106 where the ink from the cartridge 102 can be released and enable in wringing. Tip 105 extends between retracted position 200 and protracted position 201 from the front end of the housing 101.

A speaker member 300 is connected at the bottom end 104 of the housing 101. Speaker member 300 has a switch member 301. When the tip member 105 is pressed against a paper or similar platform the tip member retracts by pushing the ink cartridge 102 towards the switch member 301 of the speaker member 300 by turning the speaker member 300 to release a sound with different frequencies. As the user presses down on the marker the ink inside to move up and hit the button triggering the sound of the note.

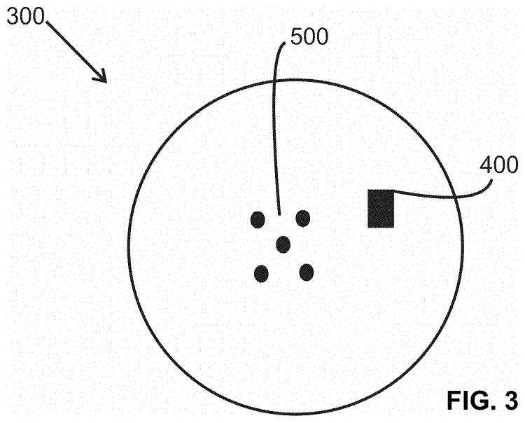

FIG. 3 represents the aerial view of the speaker member 300 with a controlling switch 400, which can be turned on/off when in use or not in use and a diaphragm 500 emitting sound.

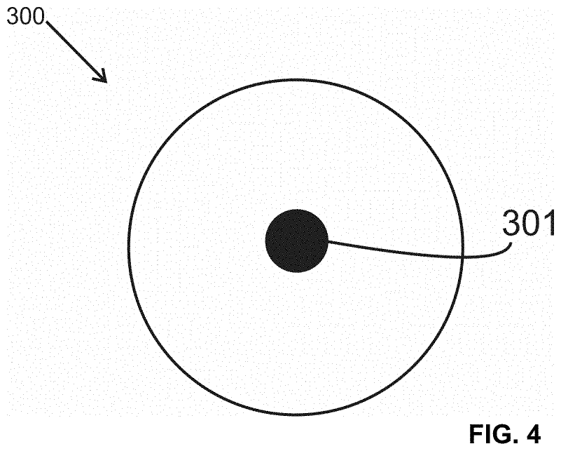

FIG. 4 represents the bottom view of the speaker present on the bottom end of the housing 104 where the switch member 301 is present.

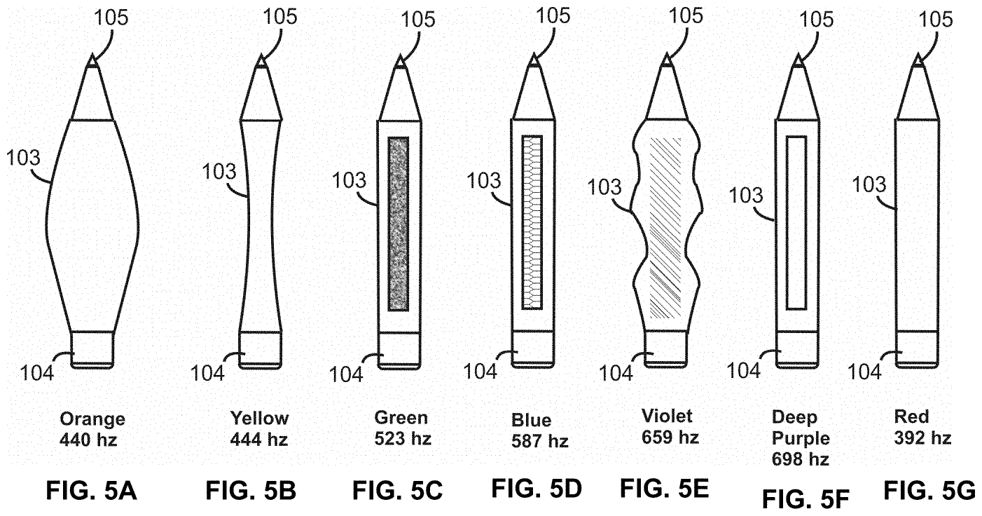

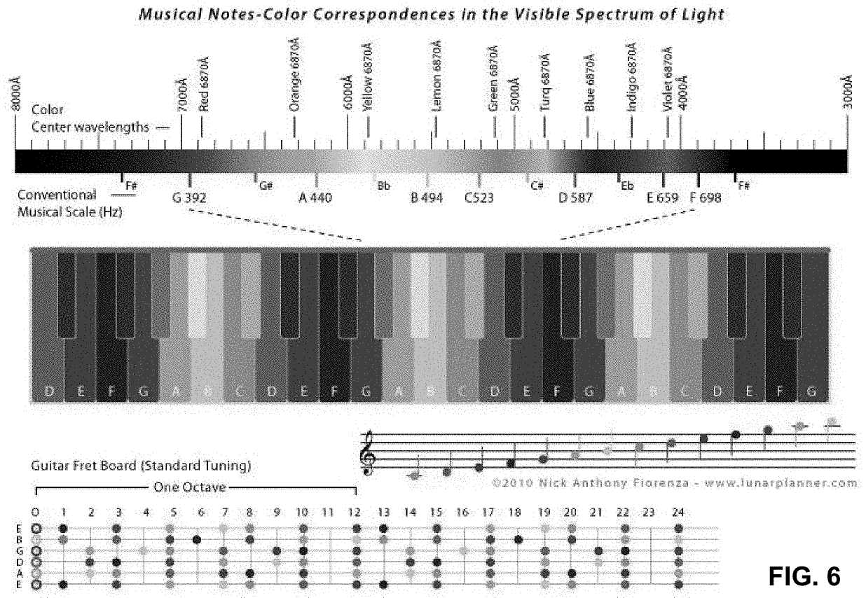

FIG. 5A to 5G represent different embodiments of the present invention. The housing 101 of the sensory toy gear can be constructed in various shapes. Each shape can produce different sound and develops a specific skill of the student. By pressing the instrument on a paper, it will produce a sound for as long as pressing it. The frequency of the sound will match the colour.

FIG. 5A (orange) has a wider body 103 and narrows at the tip part 105 and bottom end 104. This shape develops fine motor skills called palmar grasp which refers to the muscles used to grab and hold an object with the fingers and palms. The sensory toy with this shape will release a sound with a frequency of 440 HZ by pressing the tip on a paper by the user.

FIG. 5 B (yellow) The shape of this marker is wide at the tip part 105 and the bottom end 104 and narrow in the body 103. This is to help develop the fine motor skills in the hand called finger grasp. Finger grasp refers to the muscles used to pick up things with the fingers. The sensory toy with this shape will release a sound with a frequency of 494 HZ by pressing the tip 105 on a paper by the user.

FIG. 5 C (green) In one embodiment the sensory toy of the present invention has a shaker sensory as well. The housing 101 will be filled with colourful beads. this shape will release a sound with a frequency of 523 HZ by pressing the tip 105 on a paper by the user.

FIG. 5 D (blue) represents an embodiment of the present invention in which the body is filled with colourful glitter. The glitter will act as another visual sensory and release a sound with a frequency of 587 HZ by pressing the tip 105 on a paper by the user.

FIG. 5E (violet) represents an embodiment of the present invention in which the outside is made of any safe material that can be squishy. This will be a touch sensory element. this shape will release a sound with a frequency of 659 HZ.

FIG. 5F (purple) the outer surface of this marker has small bumps to give it a rough and bumpy sensation. This shape will release a sound with a frequency of 698 HZ by pressing the tip 105 on a paper by the user.

FIG. 5G (red) the outer surface of this marker is smooth and release a sound with a frequency of 392 HZ by pressing the tip 105 on a paper by the user.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1) A writing instrument comprising:
a housing having a body, a first opening and a second opening, an inner side and an outer surface;
a tip capable of moving between a retracted position and a protracted position from said first opening and said second opening;
a cartridge having an elongated portion, which moves from a first position to a second position attached to said tip;
a speaker member attached to said second opening and capable of producing a sound;
a switch member attached to said speaker member to receive said cartridge in said housing wherein when said tip is moved to protracted position said cartridge moves from said first position to said second position;
whereby turning on said switch member to produce sound.

2) The writing instrument of claim 1, wherein said ink cartridge comes in different colors.

3) The writing instrument of claim 1, wherein the sound produced from said speaker member is unique to a color of said cartridge.

4) The writing instrument of claim 1, wherein said housing of said writing instrument has different shapes and grips for developing a specific skill.

5) The writing instrument of claim 1, wherein said instrument has different colors representing a certain characteristic information.

6) The writing instrument of claim 1, wherein said instrument is wide at said body and narrows at said tip part and said bottom end to develop fine motor skills especially palmar grasp.
whereby to release a sound with a frequency of 440 HZ by pressing said tip on a paper by the user representing color orange.

7) The writing instrument of claim 1, wherein said instrument is wide at said tip part and said bottom end and narrow at said body to help develop the fine motor skills in the hand called finger grasp;
Whereby to release a sound with a frequency of 494 HZ by pressing said tip on a paper by the user representing color yellow.

8) The writing instrument of claim 1, wherein said instrument has a shaker sensory;
whereby to release a sound with a frequency of 523 HZ by pressing said tip on a paper by the user representing color green.

9) The writing instrument of claim 1, wherein said body of said instrument is filled with colorful glitter to provide a visual sensory;
whereby to release a sound with a frequency of 587 HZ by pressing said tip on a paper by the user representing color blue.

10) The writing instrument of claim 1, wherein said outer surface of said body is made of any safe and squishy material as a touch sensory element;
whereby to release a sound with a frequency of 659 HZ representing color violet.

11) The writing instrument of claim 1, wherein said outer surface of said instrument comprises of small bumps to provide a rough and bumpy sensation;
whereby to release a sound with a frequency of 698 HZ by pressing said tip on a paper by the user representing color purple.

12) The writing instrument of claim 1, wherein said outer surface of said instrument is smooth;
Whereby to release a sound with a frequency of 392 HZ by pressing said tip on a paper by the user representing color red.
